(19) United States
(12) Patent Application Publication
(10) Pub. No.: US 2004/0256596 A1
(43) Pub. Date: Dec. 23, 2004

(54) Sulfosuccinamate surfactants as deposition inhibitors

(76) Inventors: Duy T Nguyen, Austin, TX (US); George A Smith, Austin, TX (US)

Correspondence Address: Russell R Stolle, Huntsman Corporation, P O Box 15730, Austin, TX, 78761, US

(21) Appl. No.: 10/496,899

(22) PCT Filed: Nov. 22, 2002
(86) PCT No.: PCT/US02/37656

Related U.S. Application Data
(60) Provisional application No. 60/333,889, filed on Nov. 28, 2001.

(51) Int. Cl. C02F 5/00

(52) U.S. Cl. 252/175

(57) ABSTRACT

Provided herein are compositions useful for inhibiting the formation of gummy residues on equipment in processing operations which liberate tiny adhesive particles having a tendency to agglomerate into larger particles and/or films. The compositions comprise a complex or adduct formed from an anionic form of an alkoxylated sulfosuccinamate and a di-valent metal ion. The compositions according to the invention may be added to a processing system at any point, either upstream or downstream from the location at which residues are formed. Compositions according to the invention may be applied by spray techniques or by being present in a process stream.

This invention relates to compositions of matter useful in causing tacky surfaces or materials to be rendered less tacky. More particularly, the invention relates to compositions useful in preventing coagulation in solutions comprising minute particles of tacky materials. The compositions and processes detailed herein are especially well-suited for use in paper mills and other employments where solutions containing sticky particles come into contact with process equipment and have the propensity to cause fouling of the surfaces of such equipment by agglomeration of such particles.

### BACKGROUND

The formation of troublesome agglomerations of sticky bodies in aqueous solutions used in processing various chemical materials has been observed in various systems for some time. Such formation is a particular noteworthy problem in the paper and pulp manufacturing industry, regardless of the method used to pulp raw wood. There are two general methods which are recognized by those in the paper sciences for making a pulp from which many useful products may be derived. The qualities of the pulp produced by each process renders them each useful in particular end-use applications.

The first of such processes is a chemical process, which is known as the “kraft” process, and involves chemically treating wood chips and the like at an elevated temperature with a strongly alkaline aqueous solution of sodium sulfide in order to produce a pulp having most of the lignins and resins removed from the interstices between the individual fibers.

The second of such processes is known as mechanical pulping and entails forcing de-barked logs against a grinding stone or metal disks called “refiners” in order to produce a pulp. From the mechanical process is produced a pulp product having more of the lignins and the resins remaining in the pulp than in the Kraft process. There are other processes employed for pulping, which contain some character of each of the chemical and the mechanical processes. In one variant, wood chips are treated with steam in the presence of caustic soda for a prescribed time prior to being subject to grinding in the mechanical process. In another variant, wood chips are impregnated with sulfur compounds prior to the steaming.

Regardless of the method used to produce a pulp, all pulping processes are carried out in the presence of water, which is capable of acting as a carrier for all of the materials present during the pulping. Some of the materials include as aforesaid, the resins and lignins, which are capable of existing in the form of soaps. One particularly troublesome property of these materials is that while soluble at high pH levels, they tend to exist in the form of particulate precipitates in the presence of divalent metal ions, such as the alkaline earth metals. The nature of these particulate precipitates is that they are generally very sticky on their exterior and thus have a propensity towards formation of larger gummy globules and/or films on equipment with which they come into contact. This problem is typically manifest at the point at which the soluble resin and lignin first come into contact with a source of di-valent metal cation, which in the case of the chemical process is usually in the first washer which the pulp encounters after leaving the digesters because this is where fresh rinse water containing di-valent metal ions enters such a chemical pulping system. The initial deposition of such particles is often in the form of a rough film. As deposition continues, thick incrustations form, particularly on exposed edges to such an extent as to interfere with the operation of the pulp mill equipment. Eventually, portions of, or even the whole operation must be shut down to enable cleaning of the machinery, which is a costly and time-consuming endeavor.

Another class of materials known as “stickies” are troublesome in pulping and like operations. Whereas pitch, resin, and the like arises from the processing of virgin pulp, stickies arise from secondary fibers. “Stickies” are described in U.S. Pat. No. 4,956,051 which is incorporated in its entirety herein by reference thereto.

The prior art is replete with the attempts of various workers to prolong or even eliminate the formation of such deposits on paper mill equipment. For example, U.S. Pat. No. 3,992,249 which is incorporated herein in its entirety by reference thereto, teaches a process for inhibiting the deposition of adhesive pitch particles onto the surface of pulp-making equipment, prior to beating, from the water with which a cellulose fiber suspension having a content of the particles is being washed. The process comprises washing the suspension in a pulp washer containing an aqueous solution of an anionic polymer containing at least about 25 mol percent, but not more than about 85 mol percent, of hydrophobic-oleophilic linkages. Hydrophobic oleophilic linkages suitable for this employment are selected from the group comprising styrene, isobutylene, methylstyrene, allyl stearate, octadecyl acrylate, octadecene, dodecene, n-octadecylacrylamide, vinyl stearate and vinyl dodecyl ether. Also present in the solution is at least about 15 mol percent, but not more than about 75 mol percent, of hydrophilic acid linkages. Hydrophilic acid linkages suitable for this use are selected from the group comprising acrylic acid, methacrylic acid, maleic acid, itaconic acid, acrylamidoacetic acid, maleamic acid and styrenesulfonic acid. A pitch-polymer complex of the particles and the polymer is formed by their admixture, which is removed with the water used to wash the cellulose fiber suspension. Thus, substantially all of the pitch-polymer complex is separated from the cellulose fiber suspension. The amount of the polymer used is in the range of about 0.5 to 100 parts by weight per million parts by weight of the suspension.

U.S. Pat. No. 4,184,912 which is incorporated herein in its entirety by reference thereto, teaches a method of inhibiting pitch formation in paper mill pulp systems which comprises adding to such systems, at a point prior to where pitch deposits normally occur, at least 0.5 ppm, based on the weight of the pulp, of a composition comprising varying amounts of surfactants. One such system contains varied amounts of: Non-ionic surfactant; Anionic Dispersant; Anionic Polymer having molecular weight less than 100,000. In another embodiment, the surfactants comprise: an ethoxylated phenol; an alkyl-substituted naphthalene sulfonate; and an acrylic acid co-polymer (molecular weight between 5,000 and 40,000).

U.S. Pat. No. 6,143,800 which is incorporated herein in its entirety by reference thereto, discloses compositions and methods for inhibiting deposition of organic contaminants in equipment associated with a pulping operation which entails the addition of a composition comprising: a dinonyl sulfosuccinate anionic surfactant; and a multivalent cation to the system wherein the weight ratio of said dinonyl sulfosuccinate anionic surfactant to multivalent cation ranges from about 1:4 to about 1:100. A composition embraced by the above-mentioned description is added to the pulp or the surfaces of pulping mill machinery in an effective deposition inhibiting amount.

However, each of the methods of the prior art has its own drawbacks. For example, the teachings of U.S. Pat. No. 3,992,249 uses calcium to form pitch and subsequently adds a sodium salt copolymer to prevent further deposition of unwanted solids such as pitch, stickies, and the like. U.S. Pat. Nos. 4,184,912 and 6,143,800 claim the use of surfactants to control the deposition of stickies, pitch, and the like, but when the fiber slurry is diluted with white water from the paper-making machinery the surfactants tend to de-sorb from the surfaces of the stickies, pitch, and like particles. As a result the particles once again become susceptible to agglomeration with themselves and other particles, and are hence once again susceptible to re-deposition.

### SUMMARY OF THE INVENTION

The present invention provides an aqueous composition of matter useful in inhibiting deposition of various materials including resins, pitch, and lignins in aqueous systems, and especially those found in pulp mills and paper mills, which comprises:

a) an alkoxylated sulfosuccinamate component comprising a water soluble anionic form of a compound described by the formula:

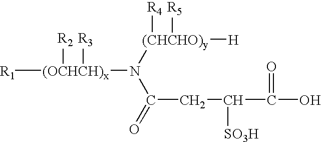

in which R₁ is a hydrocarbyl group containing between 5 and 19 carbon atoms, saturated or unsaturated, straight-chain, branched, or cyclic; R₂ and R₃ may each independently be a hydrogen, or a hydrocarbyl group selected from the group consisting of: methyl and ethyl; x may be any integer between 1 and 20, including 1 and 20; R₄ and R₅ may each independently be a hydrogen, or a hydrocarbyl group selected from the group consisting of methyl and ethyl; and y is independently equal to zero or 1; and

b) a metal component comprising at least one multivalent cation selected from the group consisting of: calcium, magnesium, strontium, barium, nickel, copper, tin, cobalt, iron, zinc, or mixtures thereof, wherein the ratio of the sulfosuccinamate component to the metal component is in the range of between 1:2 to 1:100 on a weight basis.

### DETAILED DESCRIPTION

The present invention is concerned with preventing the deposition of particles derived from lignin, pitch, resin, and the like onto various articles and pieces of process equipment and these terms are intended herein to refer to any material which can be considered to form a sticky residue including without limitation: natural resins (fatty and resin acids, fatty esters, insoluble salts, sterols, etc.); defoamers (oil, EBS, silicate, silicone oils, ethoxylates); sizing agents (rosin size, ASA, AKD, hydrolysis products, insoluble salts); coating binders (PVAC, SBR); Waxes, Inks, Hot melt glues (EVA, PVAC, amorphous polyolefins); contact adhesives (SBR, vinyl acrylates, polyisoprene, and the like). From a physical standpoint, such deposits typically form from microscopic particles of materials having adhesive outer surfaces in the stock which accumulate on papermaking or pulping equipment. Such deposits are often found on stock chest walls, paper machine foils, Uhle boxes, paper machine wires, wet press felts, dryer felts, dryer cans, and calendar stacks. Such particles formed from resins, pitch, lignins and the like are usually particles of visible or nearly visible size.

The present invention provides compositions of matter which comprise at least one anionic form of an alkoxylated sulfosuccinamate surfactant in combination with a multi-valent metal cation, which compositions are preferably aqueous solutions comprising these components. The alkoxylated sulfosuccinamate component useful as a component of a composition according to the invention is preferably provided in the form of an aqueous solution of its alkali metal salt, such as the monosodium salt, although other suitable metals include lithium, potassium, rubidium, etc. An alkoxylated sulfosuccinamate surfactant useful according to the present invention comprises an anionic form of a material described by the formula:

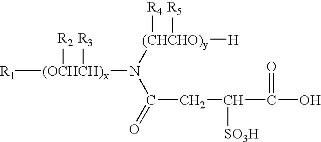

in which R₁ is a hydrocarbyl group containing between 5 and 19 carbon atoms, saturated or unsaturated, straight-chain, branched, or cyclic; R₂ and R₃ may each independently be a hydrogen, or a hydrocarbyl group selected from the group consisting of: methyl and ethyl; x may be any integer between 1 and 20, including 1 and 20; R₄ and R₅ may each independently be a hydrogen, or a hydrocarbyl group selected from the group consisting of: methyl and ethyl; and y is independently equal to zero or 1. The formation of an anion of a material represented by the above structure is a simple matter, as any chemist recognizes. All which is necessary for the formation of an anion of such species is to mix it with water, as the sulfonic acid group readily loses a proton in aqueous media. It is immediately recognizable by one of ordinary skill that the above structure also contains a carboxylic acid function, which is capable of losing a proton in aqueous media, albeit to a lesser extent than the sulfonic acid group. Nevertheless, such structure as above does contain two acid groups, which are capable of neutralization by usual means. Usual means for neutralization include the contacting of an aqueous base to such material to form a salt. The above material is thus able to neutralize two equivalents of a base. Suitable bases for neutralizing the above material to an anionic form, which term as used herein includes both anionic forms (mono-negative and di-negative) possible from such structure, include hydroxides of the alkali metals, hydroxides of alkaline earth metals, aqueous ammonia, and substituted amines, such as alkyl amines, aryl amines, alkylaryl amines, and alkanolamines known to those skilled in the art. Thus, there are many ways to arrive at an anionic form of the above material, as known by those skilled in the art.

Sulfosuccinamates are a class of materials whose preparation is known to be conducted by reacting an aliphatic primary amine in a first reaction step with maleic acid anhydride, thus:

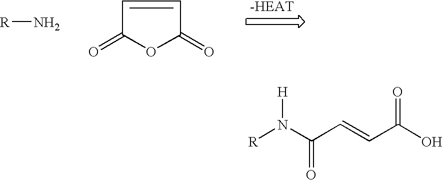

in order to form an unsaturated carboxylic acid possessive of an amide functionality, in which R is typically a C₆ to C₁₈ hydrocarbyl group. The unsaturation in the □-carbon of the resulting carboxylic acid may next be sulfonated using sodium bisulfite:

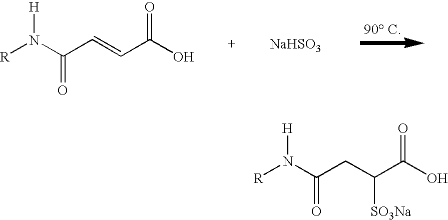

to provide a water-soluble sulfosuccinamate surfactant as the end product. However, one significant drawback of the prior art when using aliphatic amines as a reactant with maleic acid anhydride according to such a scheme is that unsaturated carboxylic acids produced in such reactions are solids at ordinary temperatures, which causes them to be difficult to handle and sluggish in their ability to solubilize in water. This is burdensome, since it is typically desirable to conduct the bisulfite addition in aqueous media, and undissolved solids do not sulfonate well. In addition, the Krafft temperatures of the final resulting sulfosuccinamates of the prior art are relatively high, which means that their ability to form micelles and to thus effectively behave as surfactants is hindered under most conditions in which they might have otherwise found use.

By our invention, we have discovered that sulfosuccinamates made using polyetheramines and maleic anhydride as reactants, when combined with a divalent metal cation in aqueous solution, are combinations which are especially useful for preventing or reducing deposition of sticky bodies in paper mills and other processes in which solids agglomeration tends to foul equipment. The sulfosuccinamate surfactants used in the present invention are more easily handled than those prepared using the analogous prior art intermediate made using aliphatic amines. Further, it has been discovered that sulfosuccinamate surfactants made by bisulfite addition to the polyetheramine-derived unsaturated carboxylic acid intermediates are possessed of a much lower Krafft temperature than are their analogous prior art sulfosuccinamate surfactants made using aliphatic amines.

To prepare a sulfosuccinamate that may be used according to a preferred form of the invention, a detergent-range alcohol (one in which R has any number of carbon atoms in the range of between about C₅ to C₁₉ in the following formula)

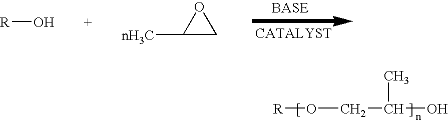

is reacted with an alkylene oxide (ethylene oxide, propylene oxide, etc.) to yield an alkoxylated alcohol:

Such an alkoxylated alcohol is next subject to amination, which effectively causes the hydroxy group on the alcohol to be replaced by an amino group:

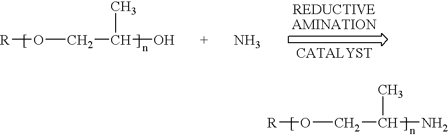

Although other methods of providing amines from such alcohols are known, including oxime reduction, Curtius, Schmidt, Ritter, Leuckart, and Hoffman reactions, reductive amination is most preferred owing to its economics. The polyoxyalkyleneamine product from the reaction immediately above is subsequently reacted with maleic acid anhydride to yield the corresponding unsaturated carboxylic acid, which may subsequently be subjected to bisulfite addition (sodium salt) to yield the sodium salt of the sulfosuccinamate surfactant (I) below:

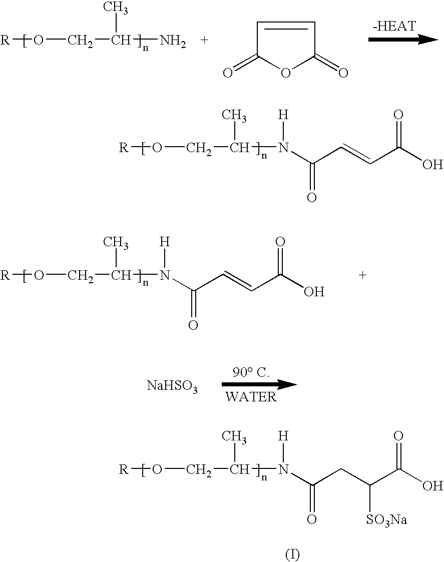

According to one preferred form of the invention, a C₅-C₁₉ alcohol, (or a commercial mixture of alcohols falling within this carbon number range), is reacted with 2 moles of propylene oxide, and the resulting alcohol (or mixture) is subsequently caused to undergo reductive amination. Any number of commercially-available alcohols may be used for this purpose. Typically, alcohols of commerce are actually mixtures of alcohols, as exemplified by that containing a mixture of C₆ to C₁₀ alcohols marketed by BP Chemicals under the tradename EPAL®610. BP Chemicals also markets a mixture of C₁₂ to C₁₄ alcohols under the tradename EPAL® 1214. BP Chemicals also markets a mixture of C₁₄ to C₁₆ alcohols under the tradename EPAL® 1416. BP Chemicals also markets a mixture of C₁₆ to C₁₈ alcohols under the tradename EPAL® 1618. Mixtures of alcohols such as these are typical in the marketplace, being marketed by Shell Chemicals, ExxonMobil, and Sasol, to name but a few. Thus the present invention contemplates the use of alcohol mixtures to prepare alkoxylated sulfosuccinamate according to the present invention. In such cases when a mixture of alcohols is used as starting material, the yield comprises a mixture of polyalkoxylated sulfosuccinamates.

The primary amine(s) so formed is reacted with maleic acid anhydride to afford the monoamide, which is next sulfonated using sodium bisulfite. The resulting products, exemplified by (I) above in their anionic forms in which n=2 according to one preferred from of the invention, are clear, low viscosity liquids having an actives content of about 30%. The anionic form of any material exemplified by (I) above or similar sulfonic acids also having a carboxylic function are, in the alternative, readily prepared by admixture of a stoichiometric amount of strong (aqueous) base, such as sodium, potassium, etc., hydroxide with the acid form of the material exemplified by (I) above.

According to the invention, it is possible to employ any alkoxylated amine as a reactant with maleic acid anhydride to provide an unsaturated carboxylic acid; provided that the amine comprises a nitrogen atom having at least one active hydrogen atom attached to the nitrogen atom. For purposes of this invention and the appended claims, an alkoxylated amine is any organic amine which has been reacted with an alkylene oxide selected from the group consisting of: ethylene oxide, propylene oxide, or butylene oxide to the extent that the product of such reaction includes at least one mole of an alkylene oxide in its molecular structure. For purposes of this invention, a hydrogen atom is considered to be an active hydrogen atom if it is capable of participating in the Zerevitinov reaction (Th. Zerevitinov, Ber. 40, 2023 (1907)) to liberate methane from methylmagnesium iodide. Such suitable materials include, without limitation, those available from Huntsman Petrochemical Corporation of Austin, Tex. under the trade names JEFFAMINE® D-230; JEFFAMINE® D-400; JEFFAMINE® D-2000; JEFFAMINE® XTJ-502; JEFFAMINE® XTJ-505; JEFFAMINE® XTJ-506; JEFFAMINE® XTJ-507; JEFFAMINE® M-2070; JEFFAMINE® XTJ-510; and JEFFAMINE® EDR-148. However, the most preferred amine reactants to be reacted with maleic acid anhydride for producing an unsaturated carboxylic acid intermediate in accordance with the invention are those which are described by the general formula:

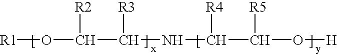

in which R1 may be any hydrocarbyl group, but is preferably an alkyl group containing between 5 and 19 carbon atoms, whether saturated or unsaturated, straight-chain, branched, or cyclic; R₂ and R₃ may each independently be: a hydrogen, or a hydrocarbyl group selected from the group consisting of: methyl and ethyl; x may be any integer between 1 and 20, including 1 and 20; R₄ and R₅ may each independently be: a hydrogen, or a hydrocarbyl group selected from the group consisting of: methyl and ethyl; and y is equal to 0 or 1. When using such amines as reactants with maleic anhydride, products represented by the formula:

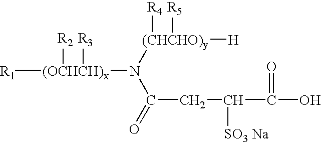

may be obtained in accordance with the reaction scheme previously given in which R₁ may be any hydrocarbyl group, but is preferably an alkyl group containing between 5 and 19 carbon atoms, whether saturated or unsaturated, straight-chain, branched, or cyclic; R₂ and R₃ may each independently be: a hydrogen, or a hydrocarbyl group selected from the group consisting of: methyl and ethyl; x may independently be any integer between 1 and 20, including 1 and 20; R₄ and R₅ may each independently be: a hydrogen, or a hydrocarbyl group selected from the group consisting of: methyl and ethyl; and y is independently equal to zero or 1. Although the formula immediately preceding represents a family of surfactants in which both the carboxylate and sulfonate portions of the molecule may exist in their acid forms, various alkali metal, alkaline earth metal, or other salts are readily obtainable from such materials by simple neutralization, as the derivation of such salts from materials containing carboxylate and sulfonate functions are well known to those in the organic chemistry art.

### Exemplary Alkoxylated Sulfosuccinamate Preparation

The preparation of a sulfosuccinamate according to the present invention may be effected by charging 18.25 grams of JEFFAMINE® C-300 to a reactor, heating it to 80 degrees centigrade, and subsequently slowly adding 5.97 grams of maleic acid anhydride to the amine with gentle mixing. The quick reaction between the amine and anhydride is exothermic, and the mixing is continued for one hour, during which time the contents of the reactor are maintained below 100 degrees centigrade. The weights of the components may be adjusted to any desired level to provide any desired quantity of a mono-amide product. 145.32 grams of such monoamide is added to 300.75 grams of de-ionized water and 90 grams of propylene glycol, and stirred until homogeneous. The pH of the mixture is adjusted to 7.0 using 20% aqueous NaOH, and the mixture is heated to a temperature in the range of about 35 to 40 degrees centigrade, after which 8.67 grams of sodium bisulfite is added to the mixture, and the temperature is subsequently raised to 100 degrees centigrade. Once the temperature has reached 100 degrees, an additional 26.04 grams of sodium bisulfite is added in small increments over the course of one hour, with gentle mixing. The reaction mixture is then cooled to room temperature to yield the sulfosuccinamate product. For producing other sulfosuccinamates, the same procedure is used, with the exception that the stoichiometric amount of the reactants are adjusted to provide the reactants in the same relative molar proportions as above. This procedure is useful for producing all of the sulfosuccinamates useful in the invention. Through the use of different starting alcohols and alkoxylating agents, different alkoxylated amines may be prepared which are useful as reactants with maleic anhydride according to the above reaction scheme. Thus, in the formula:

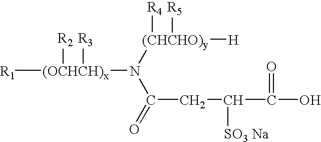

R₁, R₂, R₃ and x are readily variable. By selection of the starting alcohol, the alkyl chain length of R₁ may be custom tailored. By selecting the alkoxylating agent and the degree of alkoxylation, the variables R₂, R₃, and x may be conveniently modified. Once the selected alcohol has been alkoxylated, an amination process is employed to cap the alcohol with an amino group. This is the general means by which amines such as JEFFAMINE® C-300 are prepared. The addition of the alkoxy moiety having R₄ and R₅ substituents may be done as a final reaction step, when desired, so as to only add 1 mole (y=1), as such addition of a single mole of alkoxide is readily effected by admixture of the amine with the alkoxylating agent in the absence of a catalyst, which single mole addition of an alkoxylating agent to an amine in the absence of a catalyst is well known in the art. Subsequent reaction with maleic anhydride followed by bisulfite addition yields the sulfosuccinamate.

### The Multivalent Metal Component

Compositions prepared in accordance with, and useful in, a preferred form of the present invention include a multivalent metal component (or “metal cation” component). It is preferred that a multivalent cation used in the present invention is in a di-valent form. Thus, any metal for which stable divalent compounds are known to exist is suitable for use in the present invention. Such metals include, without limitation, magnesium, calcium, strontium, barium, nickel, copper, tin, cobalt, iron, and zinc. It is more preferred that the multivalent metal is a metal selected from the group consisting of the alkaline earth metals. It is most preferred that the multivalent metal is selected from the group consisting of calcium and magnesium.

To form a composition according to a preferred form of the invention, one begins with a first solution that contains a water soluble salt or solution of the anionic form of the alkoxylated sulfosuccinamate, and a second solution that contains a soluble aqueous solution of the desired divalent metal. A vessel containing either of the solutions is caused to undergo agitation, and a stream of the second solution is slowly added to the first. Upon mixing of the two solutions, a clear solution is formed. It is this final clear solution that results from admixture of the sulfosuccinamate with a multivalent metal ion that is useful as an anti-coagulant in accordance with a preferred form of the present invention. Such a final solution containing an anti-coagulant may be simply added to a pulp mill's water system at any location which is upstream from the point where the pitch, resin, or lignin-derived material first comes into contact with calcium ions (typically from an outside water source used as rinse or process water) because calcium ions can react with pitch, resin, or lignin-derived material to form microscopic sized particulate precipitates, which particulate precipitates are capable of agglomerating with one another to form undesirable films and gummy precipitates.

In order to use a composition according to the invention, one introduces an effective deposition inhibiting amount of an aqueous composition comprising the anionic form of a sulfosuccinamate and a divalent metal cation, into a process stream in which pitch, resin, lignin, and other residues exist or are liberated. The effective concentration of the sulfosuccinamate anionic component in an aqueous composition according to the invention in the process stream is typically in the range of between about 0.5 to 150 parts per million by weight based upon the weight of the pulp in the system. According to one preferred form of the invention, the weight ratio of sulfosuccinamate anion to metal component ranges from about 1:2 to about 1:100. More preferably, the weight ratio of sulfosuccinamate anion to metal component ranges from about 1:6 to about 1:80. According to one preferred form of the invention, from about 0.2 parts per million to about 100 parts per million of the inventive composition is used in a papermaking system, based upon the total weight of the pulp in the system.

Although a solution of a multivalent metal ion and a solution of an alkoxylated sulfosuccinamate may both be added separately to an aqueous system in which stickies or the like exist, it is preferred that these materials be mixed with one another prior to their being added to the system. This is because it is believed that the two species interact with one another to form an adduct or complex which possesses anti-coagulant properties for resin, pitch, lignin, and other bodies present in these aqueous systems.

As mentioned, the compositions of the present invention are effective at inhibiting the deposition of organic contaminants in all papermaking systems regardless of the type of process employed including without limitation Kraft, acid sulfite, mechanical pulp, and recycled fiber systems. Deposition in the brown stock washer, screen room, and Decker system in Kraft papermaking processes can be inhibited according to the teachings of the invention. The present compositions can be utilized to inhibit deposition on all surfaces of any papermaking system from the pulp mill to the reel of the paper machine, including those process contents having any pH in the range of about 3 to about 11, and under a variety of other system conditions including temperatures, ionic strengths, solids content, etc. More specifically, the alkoxylated sulfosuccinamates effectively decrease the deposition not only on metal surfaces but also plastic and synthetic surfaces such as machine wires, felts, foils, Uhle boxes, rolls and headbox components. Further, the compositions of the present invention may be used with other pulp and papermaking additives including without limitation starches, whiteners such as titanium dioxide, defoamers, wet strength resins, sizing aids, and other materials known to those skilled in the art as being useful as a functional additive in a papermaking system.

The compositions of the present invention can be added to the paper-making system at any stage. They may be added directly to the pulp furnish or indirectly to the furnish through the headbox. In another form of the invention, an anti-coagulant composition prepared in accordance with the teachings herein may be sprayed directly onto pieces of equipment which are desired to be protected from the gummy precipitates or films. Also, a composition according to the invention may be sprayed onto areas upon which are already deposited gummy residues from pitch, resin, lignin, etc. Such areas may include without limitation wires, press felts, press rolls and other deposition-prone surfaces. When added by spraying techniques, the composition is preferably diluted with water to a satisfactory inhibitor concentration. Thus, a composition according to the invention may be added to any point in a pulp and papermaking system. Spraying may be conducted using a spray bar, atomizer, or other means known by those skilled in the art of providing a spray to a surface.

The compositions of the present invention can be added to the papermaking system neat, as a powder, slurry or in solution; the preferred primary solvent including without limitation, water. The compositions may be added specifically and only to a furnish identified as contaminated or may be added to blended pulps. The compositions may be added to the stock at any point prior to the manifestation of the deposition problem and at more than one site when more than one deposition site occurs. Combinations of the above additive methods may also be employed by feeding the pulp millstock, feeding to the paper machine furnish, and spraying on the wire and the felt simultaneously.

It is preferred that the weight ratio of alkoxylated sulfosuccinamate to multivalent cation in the complex formed according to the invention ranges from about 1:2 to about 1:100. More preferably, this ratio is in the range of between from about 1:6 to about 1:80. It is most preferred that the weight ratio of alkoxylated sulfosuccinamate to multivalent cation in the complex formed according to the invention ranges from about 1:10 to about 1:60.

In use in an aqueous system in which there exist chemical species derived from resins, lignins, pitch, etc. which are capable of forming microscopic particles in the presence of calcium, which particles have a propensity to agglomerate to form an insoluble fouling, gummy film on plant equipment and the like, to which a composition according to the invention is to be added, the total concentration of the alkoxylated sulfosuccinamate present which is effective for preventing agglomeration of gummy residues on plant equipment and the like is between about 0.5 parts per million to 150 parts per million of alkoxylated sulfosuccinamate, based upon the weight of the pulp or solution to which a composition according to the invention is added. It is more preferred that this concentration is in the range of about 2 parts per million to 100 parts per million of alkoxylated sulfosuccinamate, based upon the weight of the pulp or solution. It is most preferred that the total concentration of alkoxylated sulfosuccinamate present is in the range of between 3 and 80 parts per million based upon the weight of the pulp or solution to which it is added.

For purposes of the present invention, the term “an effective deposition inhibiting amount” is defined as that amount which is sufficient to inhibit deposition of residues derived from pitch, resin, lignin, and the like onto process equipment actively used in pulp and papermaking systems. The effective amount to be added to the papermaking system depends on a number of variables including the pH of the system, hardness of the water, temperature of the water, additional additives, and the organic contaminant type and content of the pulp. Generally, from about 0.5 parts to about 100 parts of the inventive composition per million parts of pulp is added to the papermaking system. Preferably, from about 2 parts to about 100 parts of the inventive composition are added per million parts of pulp in the system.

The data set forth below were developed to evaluate test results obtained through use of the present invention. However, it quickly became evident that a synergistic result was discovered with respect to the contact angle measurements and the amount of calcium ion present. The following data are included as being illustrative of the present invention and should not be construed as being delimitive thereof in any way.

### Surface Tension and Contact Angle Measurements

Contact angle measurements provide direct information about the hydrophobicity of a surface which is coated with a sticky substance, such as an agglomerated residue derived from a pitch, lignin, resin, etc. These measurements are thus capable of providing information about the change in the hydrophobicity of a surface as surface-active materials are adsorbed and/or de-sorbed at the surface. A lower contact angle indicates that the surface is less susceptible to deposition of such gummy residues. A zero contact angle is most preferred. Surface tension provides information about the surface activity of the surfactants. A lower surface tension indicates that the surfactant can emulsify and therefore stabilize the pitch dispersion more effectively. A stable dispersion will, in turn, minimize or prevent deposition.

A well-known Wilhelmy-type technique was used to obtain surface tensions and receding contact angles of a solid immersed in the solutions containing different treatments. The Kruss K-12 Tensiometer was used. The experiment was performed at room temperature (23° C.). A clean platinum plate with exactly known geometry is brought in contact with liquid and the force acting on the plate is measured via a microbalance. The surface tension of the liquid is calculated from the measured force:

λ=P/(L×COS θ)

in which λ=surface tension; P=measured (Wilhelmy) force; and L=wetted length. In this equation, θ is the contact angle between the tangent at the wetting line and the plate surface. For the determination of the surface tension, the roughened and cleaned platinum plate is used and its contact angle is zero.

A packaging tape made from a styrenebutadiene rubber and vinylic esters and a polyester film such as MYLAR® (trademark of E.I. DuPont de Nemours), were used as a solid substrate for contact angle measurements. For the testing, a clean solid substrate was clamped on a film stage, then placed in a glass test cell. The test solution was added to the cell and the whole test cell was placed inside the chamber of a goniometer. The substrate was in contact with the solution for 30 minutes and after which an air bubble was positioned on the underside of the substrate with an inverted tip. Contact angle provides information about the hydrophobicity of a simulated surface comprising a pitch, resin, or lignin and the change in the hydrophobicity as surface-active materials are adsorbed and/or de-sorbed at the surface. A lower contact angle is indicative of the surface being less susceptible to stickies and/or pitch deposition. Surface tension provides information about the surface activity of the surfactants. A lower surface tension indicates that the surfactant is likely to adsorb at the contaminant's surface and thereby, stabilizing the pitch dispersion more effectively. A stable dispersion will minimize or prevent deposition. The results of this testing are reported in Table I.

### Standard Tape Detackification Test

This test method measures the effect of chemical additives on contact adhesion. An adhesive tape (2″×4″) and a polyester coupon (2″×4″) were treated with the test solution (600 gram). The solution contained in a 600 mL beaker is placed in a water bath with agitation and heated to the desired temperature. After 30 minutes of immersion, the tape and coupon are removed from the solution and pressed to 10,000 lb force for 1 minute and then the peel force is then measured. A reduction of peel force indicates the level of detackification of the adhesive surface. The more the adhesive surface is detackified, the less the deposition potential of particulate residues derived from pitch, lignin, resin, etc. would be. The % control or detackification is calculated by the following equation:

% detackification=[(untreated force)−(treated force)]×100/untreated force

Results of this testing are set forth in Table II below:

TABLE I
Surface Tension and Contact Angle Measurements at 23° C. of
solutions having varied alkoxylated sulfosuccinamate and calcium
content.

| | | Sulfo- | | | Contact |
|---|---|---|---|---|---|
| | Sulfo- | succinamate | Ca | Surf. Tension | Angle |
| ID | succinamate | level (ppm) | (ppm) | (dyne/cm) | (degrees) |
| 1 | Deionized H₂O | 0 | 0 | 72.7 | 61.3 |
| 2 | SSA1 | 2 | 0 | 56.1 | 57.0 |
| 3 | SSA1 | 2 | 200 | 33.5 | 48.7 |
| 4 | SSA1 | 5 | 0 | 50.7 | 53.0 |
| 5 | SSA1 | 3 | 200 | 30.8 | 0 |
| 6 | SSA1 | 5 | 200 | 29.3 | — |
| 7 | SSA1 | 1 | 200 | 39.6 | — |
| 8 | SSA2 | 5 | 200 | 32.0 | — |
| 9 | DOS* | 5 | 200 | 43.1 | — |
| 10 | DOS* | 10 | 200 | 39.4 | — |

TABLE II
Standard Tape Detackification Test Results

| | | Sulfo- | | | Peel | |
|---|---|---|---|---|---|---|
| Sample | | succinamate | Ca | Temp. | Force | % detacki- |
| No. | Substance | level (ppm) | (ppm) | ° C. | (lbf) | fication |
| 1 | DI H₂O | 0 | 0 | 50 | 5.13 | 0 |
| 2 | SSA2 | 1 | 0 | 50 | 2.75 | 46.39 |
| 3 | SSA2 | 1 | 100 | 50 | 0.54 | 89.47 |
| 4 | SSA2 | 1 | 300 | 50 | 0.14 | 97.27 |
| 5 | SSA2 | 1 | 500 | 50 | 0.14 | 97.27 |
| 6 | SSA2 | 1 | 700 | 50 | 0.38 | 92.59 |
| 7 | SSA2 | 1 | 900 | 50 | 0.75 | 85.38 |
| 8 | SSA2 | 5 | 0 | 50 | 0.77 | 84.99 |
| 9 | SSA2 | 5 | 100 | 50 | 0.00 | 100.00 |
| 10 | SSA2 | 5 | 300 | 50 | 0.00 | 100.00 |
| 11 | SSA2 | 5 | 500 | 50 | 0.00 | 100.00 |
| 12 | SSA2 | 5 | 700 | 50 | 0.00 | 100.00 |
| 13 | SSA2 | 5 | 900 | 50 | 0.00 | 100.00 |
| 14 | DOS* | 5 | 100 | 50 | 0.58 | 88.69 |

In Tables I and II, the abbreviation SSA1 refers to the sulfosuccinamate having the

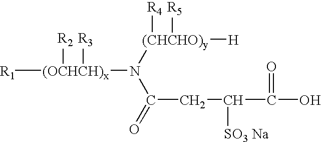

formula:

in which R₁ is a mixture of C₁₄-C₁₆ alkyl chains; R₂ is hydrogen and R₃ is methyl; x is 2; and y is zero. SSA2 is an abbreviation for the sulfosuccinamate having the same general formula as SSA1, except that R₁ a mixture of C₁₂-C₁₄ alkyl chains, R₂ is hydrogen, R₃; x is 2, and y is zero.

The results presented in Table I demonstrate that the alkoxylated sulfosuccinamates of the invention function synergistically with calcium towards minimization of the contact angle and surface tension reduction. Contact angle measurements shown were obtained using a MYLAR® substrate. Comparison of examples 2 and 3 shows the effect on contact angle and surface tension measurements effected by the presence of calcium, in which the contact angle drops dramatically, in evidence of the heretofore unknown synergy between anionic alkoxylated sulfosuccinamate species and calcium ion towards altering the hydrophobicity of a simulated surface comprising a pitch, resin, or lignin and the change in the hydrophobicity as surface-active materials are adsorbed and/or de-sorbed at the surface. Samples 9 and 10 are examples using a sulfosuccinamate of the prior art for comparative purposes, which is di-octyl sulfosuccinamate, or “DOS”. The values indicated in the tables under “sulfo-succinamate level” indicate the ppm amount of DOS present in those particular tests.

The results set forth in Table II confirm the results set forth in Table I that the efficacy of alkoxylated sulfosuccinamates towards inhibiting deposition of the residues addressed herein is significantly increased when it is used together with multivalent metallic species such as calcium ions. From examples 2-8 it is clear that increasing the calcium lowers the peel force (increases the detackification) values.

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. Accordingly, the presently disclosed invention is intended to cover all such modifications and alterations, and is limited only by the scope of the claims which follow.

We claim:

1) An aqueous composition of matter useful for treating a surface against formation of deposits, which deposits include resins, pitch, and lignins in aqueous systems, which comprises:
a) an alkoxylated sulfosuccinamate component comprising a water-soluble anion of a compound described by the formula: 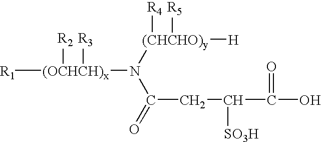
in which R₁ is independently a hydrocarbyl group containing any number of carbon atoms between 5 and 21, whether saturated, unsaturated, straight-chain, branched, or cyclic; R₂ and R₃ may each independently be a hydrogen, or a hydrocarbyl group selected from the group consisting of: methyl and ethyl; x may be independently any integer between 1 and 20, including 1 and 20; R₄ and R₅ may each independently be a hydrogen, or a hydrocarbyl group selected from the group consisting of: methyl and ethyl; and y is independently equal to zero or 1; and
b) a metal ion component comprising at least one multivalent cation selected from the group consisting of: calcium, magnesium, strontium, barium, nickel, copper, tin, cobalt, iron, zinc, or mixtures thereof, wherein the ratio of the sulfosuccinamate component to the metal component is in the range of between 1:2 to 1:100 on a weight basis.

2) A composition according to claim 1 wherein a cation selected from the group of: lithium ions, zinc ions, iron ions, aluminum ions, sodium ions, potassium ions, rubidium ions, ammonium ions, and alkyl ammonium ions is present to counterbalance the electrical charge of said anion.

3) A composition according to claim 1 wherein the ratio of the water-soluble anion to the metal component is in the range of between 1:2 to 1:100 on a weight basis.

4) A composition according to claim 1 wherein the concentration of the water-soluble anion is any concentration in the range of between 0.50 and 500 parts per million on a weight basis based upon the total weight of said aqueous composition.

5) A composition according to claim 1 in which R₁ is independently a hydrocarbyl group containing any number of carbon atoms between 5 and 21; R₂ is hydrogen; R₃ is methyl; x=2; and y=0.

6) A composition according to claim 1 in which R₁ is independently a hydrocarbyl group containing any number of carbon atoms between 5 and 21; R₂ and R₅ are hydrogen; R₃ and R₄ are methyl; x=2; and y=1.

7) An aqueous composition according to claim 1 wherein said alkoxylated sulfosuccinamate component comprises at least two different water-soluble anions described by the formulas: 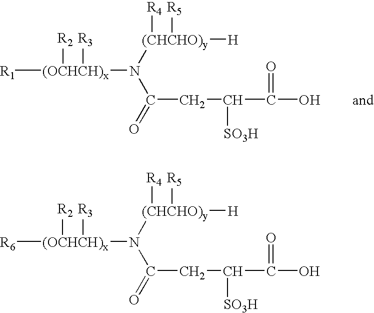
in which R₁ and R₆ in both structures may each independently be a hydrocarbyl group containing any number of carbon atoms between 5 and 21, whether saturated, unsaturated, straight-chain, branched, or cyclic; R₂ and R₃ in both structures may each independently be a hydrogen, or a hydrocarbyl group selected from the group consisting of: methyl and ethyl; x in both structures may each independently be any integer between 1 and 20, including 1 and 20; R₄ and R₅ in both structures may each independently be a hydrogen, or a hydrocarbyl group selected from the group consisting of: methyl and ethyl; and y in both structures may each independently be equal to zero or 1, provided that R₁ and R₆ are not hydrocarbyl groups which are identical to one another.

8) An aqueous concentrate comprising:
a) water; and
b) an anion of an alkoxylated sulfosuccinamate described by the formula: 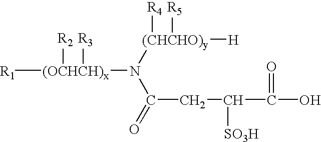
in which R₁ is independently a hydrocarbyl group containing any number of carbon atoms between 5 and 21, whether saturated, unsaturated, straight-chain, branched, or cyclic; R₂ and R₃ may each independently be a hydrogen, or a hydrocarbyl group selected from the group consisting of: methyl and ethyl; x may be independently any integer between 1 and 20, including 1 and 20; R₄ and R₅ may each independently be a hydrogen, or a hydrocarbyl group selected from the group consisting of: methyl and ethyl; and y is independently equal to zero or 1,
wherein said anion is present in any amount between 10.0% and 40.0% by weight based upon the total weight of said concentrate.

9) A process for preventing deposition of pitch, resin, stickies, lignin, and residues on processing equipment which comprises the steps of:
a) providing an aqueous composition of matter which comprises:
i) an alkoxylated sulfosuccinamate component comprising a water-soluble anion of a compound described by the formula: 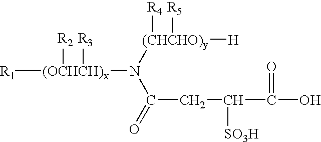
in which R₁ is independently a hydrocarbyl group containing any number of carbon atoms between 5 and 21, whether saturated, unsaturated, straight-chain, branched, or cyclic; R₂ and R₃ may each independently be a hydrogen, or a hydrocarbyl group selected from the group consisting of: methyl and ethyl; x may independently be any integer between 1 and 20, including 1 and 20; R₄ and R₅ may each independently be a hydrogen, or a hydrocarbyl group selected from the group consisting of: methyl and ethyl; and y is independently equal to zero or 1; and
ii) a metal ion component comprising an aqueous solution containing at least one multivalent cation selected from the group consisting of: calcium, magnesium, strontium, barium, nickel, copper, tin, cobalt, iron, zinc, or mixtures thereof; and
b) introducing an effective deposition inhibiting amount of said aqueous composition into an aqueous solution in which at least one residue selected from the group consisting of: pitch, resin, and lignin are present,
wherein the concentration of the alkoxylated sulfosuccinamate component of said aqueous composition in said process stream is in the range of between 0.5 parts per million to 150 parts per million by weight based upon the weight of said process stream.

10) A process according to claim 9 wherein a cation selected from the group of: lithium ions, zinc ions, iron ions, aluminum ions, sodium ions, potassium ions, rubidium ions, ammonium ions, and alkyl ammonium ions is present to counterbalance the electrical charge of said anion.

11) A process according to claim 9 wherein the ratio of the water-soluble anion to the metal component is in the range of between 1:2 to 1:100 on a weight basis.

12) A process according to claim 9 wherein the concentration of the water-soluble anion is any concentration in the range of between 0.50 and 500 parts per million on a weight basis based upon the total weight of said aqueous composition.

13) A process according to claim 9 in which R₁ is independently a hydrocarbyl group containing any number of carbon atoms between 5 and 21; R₂ is hydrogen; R₃ is methyl; x=2; and y=0.

14) A process according to claim 9 in which R₁ is independently a hydrocarbyl group containing any number of carbon atoms between 5 and 21; R₂ and R₅ are hydrogen; R₃ and R₄ are methyl; x=2; and y=1.

15) A process according to claim 9 wherein said alkoxylated sulfosuccinamate component is a mixture of at least two materials described by the formulas: 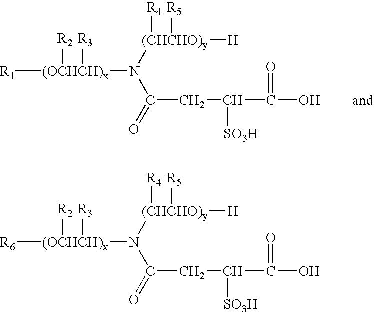
in which R₁ and R₆ in both structures may each independently be a hydrocarbyl group containing any number of carbon atoms between 5 and 21, whether saturated, unsaturated, straight-chain, branched, or cyclic; R₂ and R₃ in both structures may each independently be a hydrogen, or a hydrocarbyl group selected from the group consisting of methyl and ethyl; x in both structures may each independently be any integer between 1 and 20, including 1 and 20; R₄ and R₅ in both structures may each independently be a hydrogen, or a hydrocarbyl group selected from the group consisting of: methyl and ethyl; and y in both structures may each independently be equal to zero or 1, provided that R₁ and R₆ are not hydrocarbyl groups which are identical to one another.
